(19) United States
(12) Patent Application Publication
(10) Pub. No.: US 2025/0033175 A1
(43) Pub. Date: Jan. 30, 2025

(54) CIRCLIP PLIER TIPS

(71) Applicant: Apex Brands, Inc., Apex, NC (US)

(72) Inventors: Kyle ROMANICK, Fuquay Varina, NC (US); Zhihong FU, Cary, NC (US); Jesse Ryan HIGGINS, Raleigh, NC (US)

(21) Appl. No.: 18/911,753

(22) Filed: Oct. 10, 2024

Related U.S. Application Data
(63) Continuation-in-part of application No. 18/502,199, filed on Nov. 6, 2023.
(63) Continuation-in-part of application No. 18/502,230, filed on Nov. 6, 2023.
(60) Provisional application No. 63/428,839, filed on Nov. 30, 2022.
(60) Provisional application No. 63/428,834, filed on Nov. 30, 2022.

(51) Int. Cl. B25B 27/20

(52) U.S. Cl. CPC B25B 27/205

(57) ABSTRACT

A circlip pliers may include a head section which may include a top jaw and a bottom jaw, a handle section which may include a top handle and a bottom handle, a joint assembly which may operably couple the head section to the handle section, and a tip assembly which may include a first tip which may be disposed at a distal end of the top jaw and a second tip which may be disposed at a distal end of the bottom jaw. The first and second tips may each include a base portion, a cylindrical body portion and a retention lip which may be disposed at a distal end of the cylindrical body portion.

### CROSS REFERENCE TO RELATED APPLICATION

This application is a continuation-in-part of U.S. application Ser. No. 18/502,199 filed Nov. 6, 2023, which claims priority to provisional application No. 63/428,839 filed Nov. 30, 2022, and U.S. application Ser. No. 18/502,230 filed Nov. 6, 2023, which claims priority to provisional application No. 63/428,834 filed Nov. 30, 2022, the entire contents of each of which are hereby incorporated by reference in its entirety.

### TECHNICAL FIELD

Example embodiments generally relate to hand tools and, in particular, relate to circlip pliers.

### BACKGROUND

Hand tools are commonly used across all aspects of industry and in the homes of consumers. Hand tools are employed for multiple applications including, for example, tightening, component joining and/or the like. For some component joining applications, pliers may be adapted for specific use with circlips in applications where other components may be retained on shafts or housings of various types. In this regard, pliers may be used to either contract or expand circlips to depending on whether the circlip is externally applied or internally applied.

Often referred to as circlip pliers, retaining ring pliers, or snap ring pliers, typical circlip pliers operably couple to a circlip to allow for the pliers to either expand or contract the circlip in order to effectively apply the circlip in a desired position. Many circlips are formed as open-ended rings, rather than being one continuous and intact circle. Proximate to the open end, some circlips may include an orifice disposed on either side of the open end to which the circlip pliers may operably couple. Thus, using the open end, the circlip may rely on spring tension to retain its natural shape. In order to apply a force to either expand or contract the circlip, the circlip pliers may operably couple to the orifices disposed proximate to the open end. Thus, it may be desirable to develop circlip pliers having tips that improve the efficiency of working with circlips.

### BRIEF SUMMARY OF SOME EXAMPLES

Some example embodiments may provide for circlip pliers. The circlip pliers may include a head section which may include a top jaw and a bottom jaw, a handle section which may include a top handle and a bottom handle, a joint assembly which may operably couple the head section to the handle section, and a tip assembly which may include a first tip which may be disposed at a distal end of the top jaw and a second tip which may be disposed at a distal end of the bottom jaw. The first and second tips may each include a base portion, a cylindrical body portion and a retention lip which may be disposed at a distal end of the cylindrical body portion.

Some example embodiments may provide for a tip assembly for circlip pliers which may include a head section which may include a top jaw and a bottom jaw, a handle section which may include a top handle and a bottom handle, and a joint assembly which may operably couple the head section to the handle section. The tip assembly may include a first tip which may be disposed at a distal end of the top jaw, and a second tip which may be disposed at a distal end of the bottom jaw. The first and second tips may each include a base portion, a cylindrical body portion and a retention lip which may be disposed at a distal end of the cylindrical body portion.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a perspective view of a hand tool according to an example embodiment;

FIG. 2 is a close-up perspective view of the top jaw of the hand tool in accordance with an example embodiment;

FIG. 3 is a close-up perspective view of the bottom jaw of the hand tool in accordance with an example embodiment;

FIG. 4 is a close-up side profile view of the bottom jaw of the hand tool in accordance with an example embodiment;

FIG. 5 is a close-up top view of the bottom jaw of the hand tool in accordance with an example embodiment;

FIG. 6 depicts a close-up side view of the gripping assembly and the pin assembly in accordance with an example embodiment;

FIG. 7 is a close-up section view of the second gripping surface and the bore in accordance with an example embodiment;

FIG. 8 is a close-up top view of the first gripping surface in accordance with an example embodiment;

FIG. 9 illustrates a side view of the hand tool according to an example embodiment;

FIG. 10 illustrates a close up side view of a head section of the hand tool according to an example embodiment;

FIG. 11 illustrates a close up side view of a tip assembly of the hand tool according to an example embodiment;

FIG. 12 illustrates a side view of the hand tool according to an example embodiment;

FIG. 13 illustrates a close up side view of a head section of the hand tool according to an example embodiment; and

FIG. 14 illustrates a close up side view of a tip assembly of the hand tool according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Additionally, as used herein, terminology such as “about,” “approximately” and “substantially,” when used to refer to variability of parameters, should be understood to be definite approximations that account for variations in measurements that cannot be, or as one of skill in the art would appreciate, normally are not, measured precisely. Thus, for example, a parameter that is “about,” “approximately” or “substantially” a given value or a given characteristic should be understood to be sufficiently close to the given value or given characteristic such that performance of the object or product to which the parameter applies, from the perspective of one with ordinary skill in the art, is the same as though the object or product had precisely the given value or characteristic.

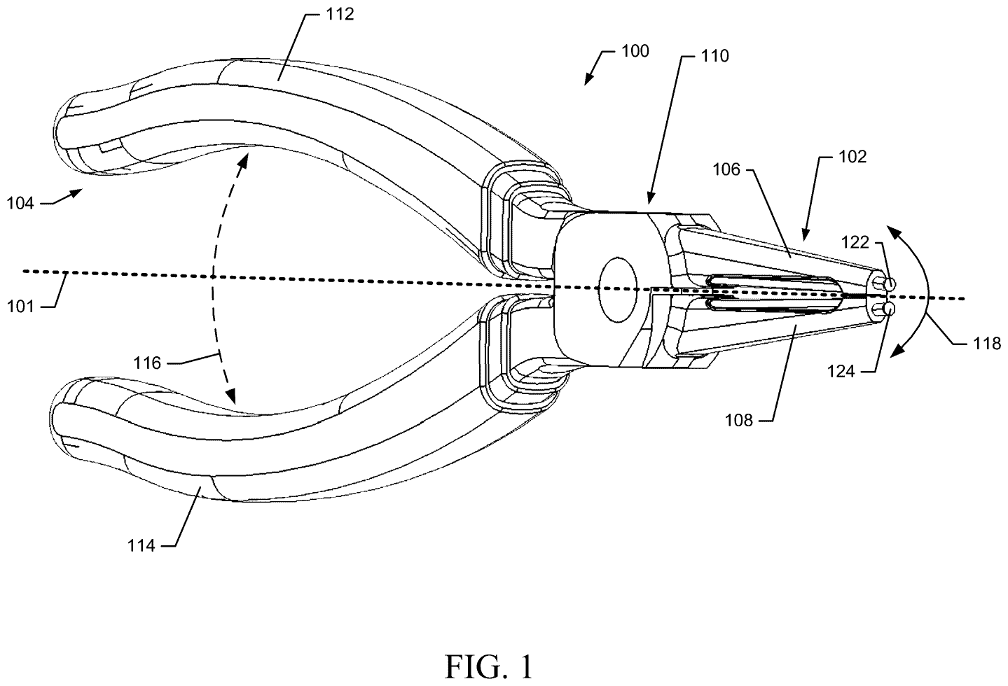

As indicated above, some example embodiments may relate to the provision of circlip pliers having tips that may enable the operator of the pliers to more efficiently install circlips (i.e. snap rings, retaining rings, etc.). Of note, the hand tool 100 of FIG. 1 should be understood to be positioned such that it can be bisected by a vertically oriented plane that passes through the longitudinal centerline 101 of the hand tool 100. The terms “top,” “bottom,” “right,” and “left” should therefore be understood as relative terms that are applicable to this particular orientation. To the extent the terms “front” and “back” are also used, the front of the hand tool 100 should be understood to be the working end thereof (i.e., the end at which the jaws are located), and the back of the hand tool 100 is the opposite end to the working end (i.e., the end at which the handles are located).

Referring now to FIG. 1, the hand tool 100 may include a head section 102 and a handle section 104. The head section 102 may include a top jaw 106 and a bottom jaw 108. The head section 102 may be separated from the handle section 104 by the joint assembly 110. The handle section 104 may include a top handle 112 and a bottom handle 114. A pin assembly 120 may be disposed at a distal end of the head section 102 at the front of the hand tool 100. In this regard, the top jaw 106 and the bottom jaw 108 may each include a bore 115 disposed at the distal end of each jaw (106, 108) that extends into the respective jaw towards the joint assembly 110. In some cases, the hand tool 100 may include a gripping assembly 130 which may include a first gripping surface 132 disposed at the top jaw 106 and a second gripping surface 134 disposed at the bottom jaw 108. The first and second gripping surfaces (132, 134) may be formed so that when the top jaw 106 is proximate to the bottom jaw 108, the first gripping surface 132 may interface with the second gripping surface 134. In some cases, each gripping surface (132, 134) may extend a distance substantially equal to the depth of the bore 115 in each of the top and bottom jaws (106, 108).

The pin assembly 120 may include a first pin 122 disposed in the bore 115 of the top jaw 106, and a second pin 124 disposed in the bore 115 of the bottom jaw 108. The first and second pins (122, 124) of the pin assembly 120 may extend out of their respective bores 115, and away from their respective jaws in which the first and second pins (122, 124) are disposed. In this regard, the hand tool 100 may operably couple to a circlip (i.e., a retaining ring) and thus may apply a force to the circlip to contract the circlip to fit in a desired location via the pin assembly 120. As such, in some cases, the circlip may include first and second orifices that may correspond to the first and second pins (122, 124) of the pin assembly 120. Responsive to the first and second pins (122, 124) operably coupling to the first and second orifices, the hand tool 100 may be used to apply a force to the circlip to contract the circlip to fit the circlip in the desired location.

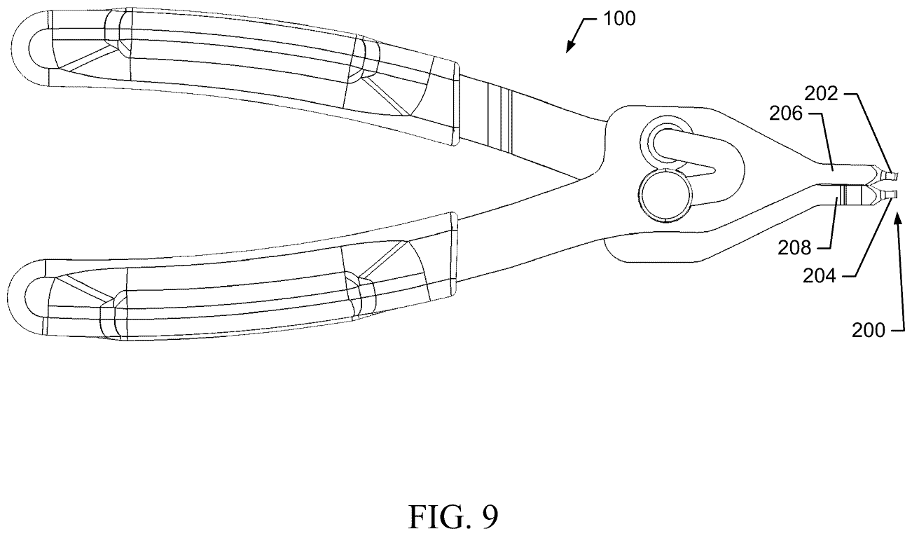

In some embodiments, the top and bottom jaws (106, 108) may not include respective bores 115, and thus the pin assembly 120 may not be disposed in the bores 115. In this regard, the pin assembly 120 may be integrally formed from the material of the top and bottom jaws (106, 108). In other words, the top and bottom jaws (106, 108) may be machined to remove some material at the distal end of each of the top and bottom jaws (106, 108) to form first and second tips. In such cases, the pin assembly 120 may also be referred to as a tip assembly 200, and the first and second pins (122, 124) may instead be referred to as the first tip 202 and the second tip 204, respectively. The tip assembly 200 will be described in further detail below in reference to FIGS. 9-14. Despite the manner in which the pin assembly 120 is operably coupled to the top and bottom jaws (106, 108), the pin assembly 120 may be capable of performing the same essential functions described below.

FIG. 1 depicts an embodiment where the hand tool 100 may be a set of internal circlip pliers. In this embodiment, the top jaw 106 and bottom handle 114 may be formed of a rigid metallic material (e.g., iron or steel, such as induction hardened steel) and the bottom jaw 108 and top handle 112 may be similarly formed of a rigid metallic material (e.g., the same material used to form the top jaw 106 and bottom handle 114). The single unitary piece comprising the top jaw 106 and bottom handle 114 may transition between the top jaw 106 and the bottom handle 114 at a transition portion that may be located at the joint assembly 110. Likewise, the single unitary piece comprising the bottom jaw 108 and top handle 112 may similarly transition between the bottom jaw 108 and the top handle 112 at a transition portion that may be located at the joint assembly 110. In this regard, the joint assembly 110 may be where the two unitary pieces of the hand tool 100 are pivotably operably coupled to each other to allow for the operation of the hand tool 100. In an example embodiment, at least some of the metallic portions of the hand tool 100 may be covered with a corrosion resistant finish (e.g., a black-oxide finish). Lengths of the top jaw 106, top handle 112, bottom jaw 108, bottom handle 114, first pin 122 and second pin 124 may be selected to provide any desirable length for the hand tool 100.

In comparison to external circlip pliers, internal circlip pliers may contract the internal circlip in order to place the circlip in the desired location. In some embodiments, for example, an internal circlip may be used to hold objects in place inside a tube, and as such, the internal circlip may need to be contracted to fit inside the tube and then released to secure itself to the interior of the tube. In this regard, the internal circlip may rely on a spring force to operably couple to the desired location, such as on the interior of the tube. Thus, in a pair of internal circlip pliers, separating the top handle 112 from the bottom handle 114 (i.e., by moving them in the direction shown by arrow 116) may pivot the top jaw 106 away from the bottom jaw 108 (i.e., in the direction shown by arrow 118), which thereby moves the first pin 122 away from the second pin 124. Then, responsive to the top handle 112 being compressed back towards the bottom handle 114, the opposite motions may occur, and the first pin 122 may move back towards the second pin 124. Accordingly, the internal circlip pliers may apply a force on the circlip to contract the internal circlip to be placed in the desired location responsive to the top handle 112 being compressed back towards the bottom handle 114.

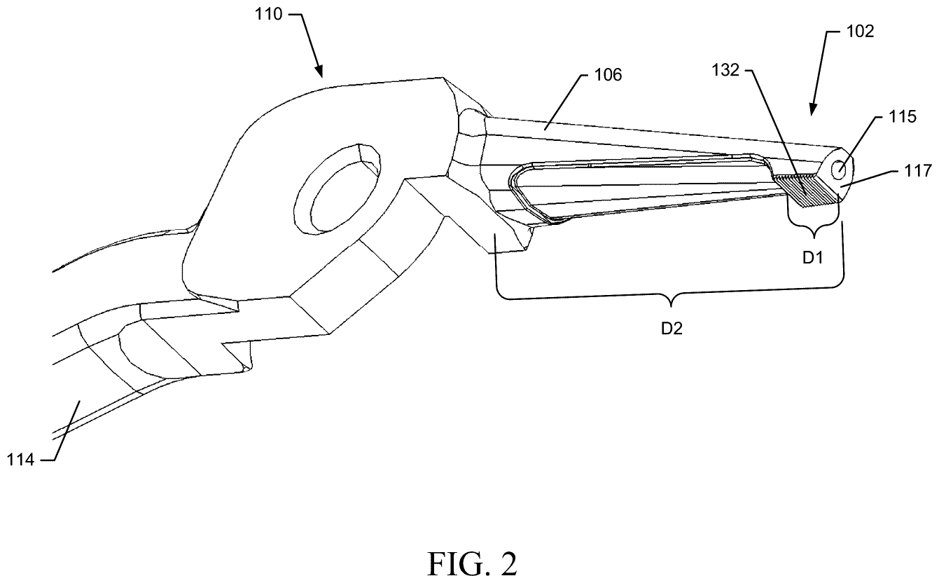

FIGS. 2-8 depict various views of portions of the hand tool 100 according to an example embodiment. Among the components shown in FIGS. 2-8, the gripping assembly 130 may often be visible. As described above, the gripping assembly 130 may include the first gripping surface 132 disposed at the top jaw 106, proximate to the first pin 122, and the second gripping surface 134 disposed at the bottom jaw 108, proximate to the second pin 124. The gripping assembly 130 may be disposed on respective inner-facing surfaces of the top and bottom jaws (106, 108) so that the hand tool 100 may grip objects between the top and bottom jaws (106, 108) via the gripping assembly 130, responsive to the top jaw 106 and the bottom jaw 108 moving towards each other.

The inclusion of the gripping assembly 130 in the hand tool 100 may be especially noteworthy in the case where the hand tool 100 described herein may be embodied as circlip pliers. In this regard, known circlip pliers are often designed to only operably couple with circlips via a circlip-specific structure (e.g., the pin assembly 120) that operably couples to the orifices disposed at the circlip in order to place the circlip in the desired location. Accordingly, known circlip pliers do not have a need for, and thus do not include, the gripping assembly 130 as part of the hand tool 100. In fact, in most cases, the mere existence of the circlip-specific structure (e.g., the pin assembly 120) that operably couples to the orifices of the circlip often suggests that the circlip pliers would not also include the gripping assembly 130 and thus would not be used to grip objects between the top and bottom jaws (106, 108). In this regard, in examples embodiments of known circlip pliers, the distal end of the jaws where they contact one another may end up as unused and/or dead space by not including the gripping assembly 130. In such cases, an operator of previously known circlip pliers may often need to have another set of pliers on-hand that they may utilize to grip objects as required by their work. For example, if the operator were to be installing the circlip in the desired location and the circlip were to become removed from its operable coupling with the existing circlip pliers, the operator would then have to utilize another set of pliers, such as needle nose pliers, to grip and retrieve the circlip. Therefore, among other solutions, the present invention may provide a solution the problem of needing separate tools for various work scenarios by implementing the gripping assembly 130 onto the hand tool 100 at the distal end of the top and bottom jaws (106, 108). Accordingly, the hand tool 100 may be a dual function tool that may operably couple with a circlip via the pin assembly 120 and may grip objects with the gripping assembly 130.

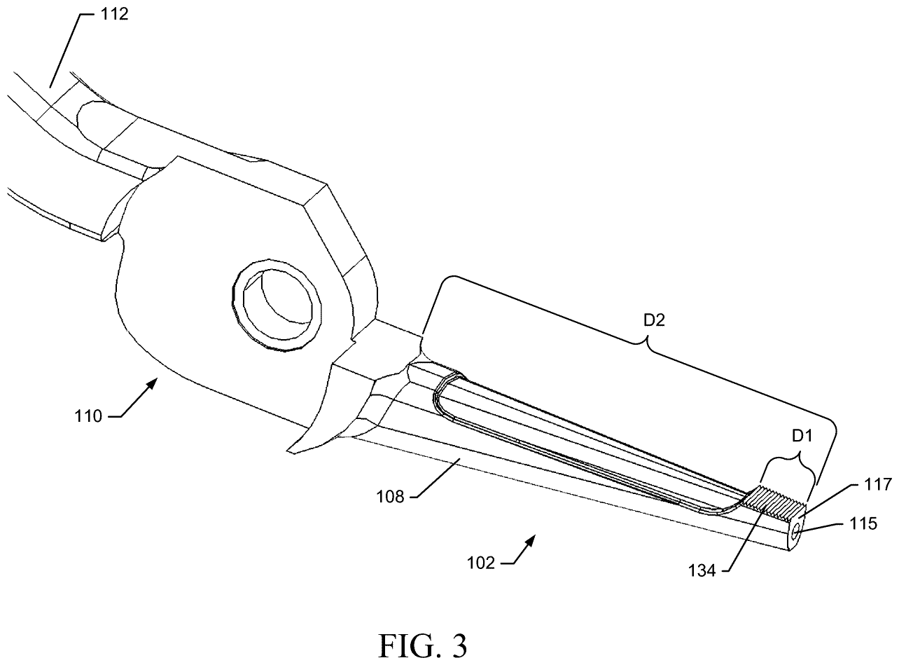

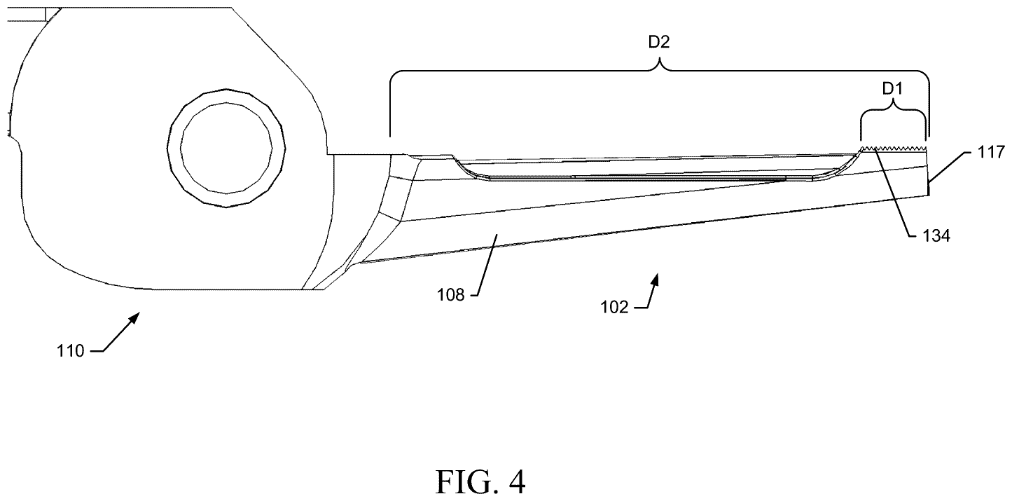

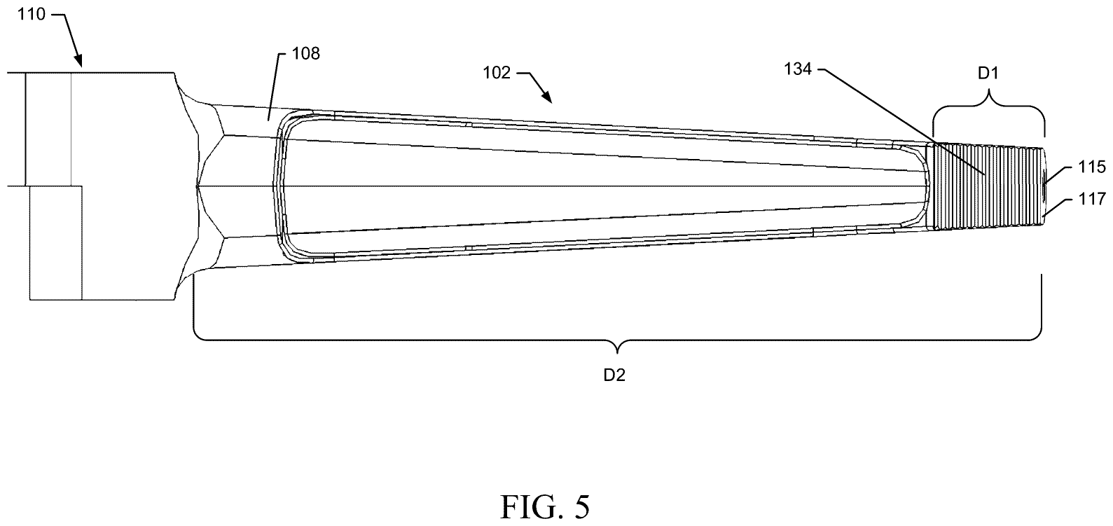

FIGS. 2 and 3 depict perspective views of the top and bottom jaws (106, 108), respectively, and FIGS. 4 and 5 depict side profile and top views of the bottom jaw 108, respectively, according to an example embodiment. As described above, the joint assembly 110 may pivotably operable couple each unitary member of the hand tool 100 together, so that the relative motion between the top handle 112 and the bottom handle 114 results in the relative motion between the top jaw 106 and the bottom jaw 108. As shown in FIGS. 2-5, the first gripping surface 132 and the second gripping surface 134 may be disposed at a distal end of the respective jaws (106, 108) proximate to the pin assembly 120. The first and second gripping surfaces (132, 134) may extend from the distal end of the respective jaws (106, 108) towards the joint assembly 110 with a length (D1) that may be roughly equal to 10% of a length (D2) of the top and bottom jaws (106, 108), respectively. In some embodiments, the first and second gripping surfaces (132, 134) may each comprise teeth 140. The teeth 140 may enhance the ability of the gripping assembly 130 to grip objects by providing more surfaces and more surface area for the gripping assembly 130 to engage with various objects. As shown in FIGS. 4 and 5, the top and bottom jaws (106, 108) may both taper as they extend from the joint assembly 110 towards the pin assembly 120. However, rather than form a point at the distal end thereof, each jaw (106, 108) may include a planar surface 117 disposed at the end of each of the top and bottom jaws (106, 108).

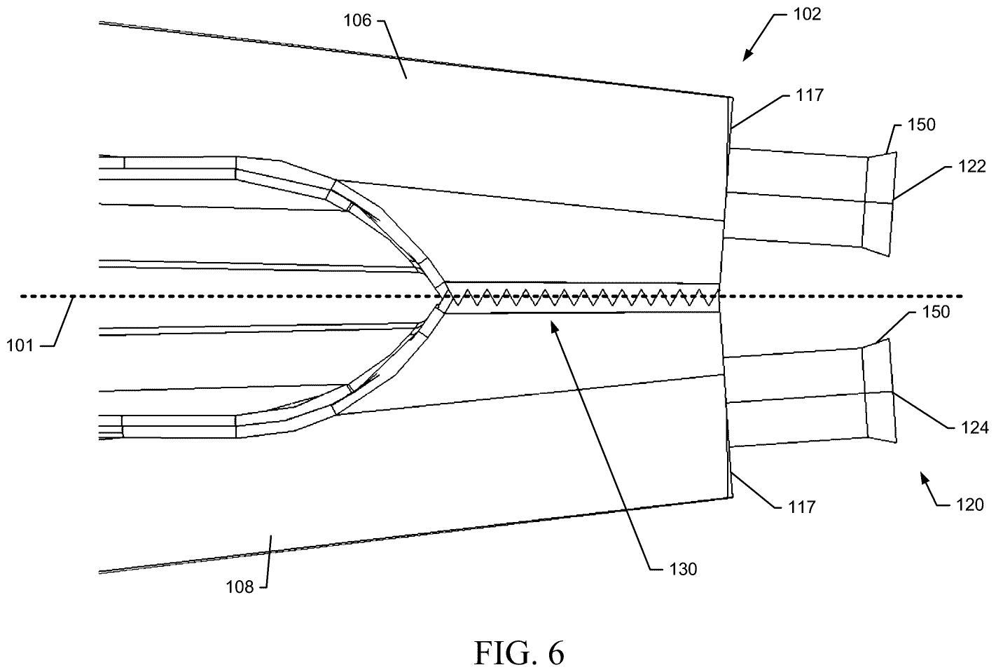

FIG. 6 depicts a close-up view of the gripping assembly 130 and the pin assembly 120 according to an example embodiment. As shown in FIG. 6, the teeth 140 of the first gripping surface 132 may interlace with the teeth 140 of the second gripping surface 134 when the top jaw 106 may be proximate to the bottom jaw 108. According to an example embodiment, the teeth 140 of the first and second gripping surfaces (132, 134) may interlace along the longitudinal centerline 101 of the hand tool 100. In this regard, the first and second gripping surfaces (132, 134) may be parallel with the longitudinal centerline 101 when the hand tool 100 is in a closed state, as depicted in FIG. 6. At the same time, the first and second gripping surfaces (132, 134) may not be parallel with the respective bores 115 within the top and bottom jaws (106, 108) nor with the first and second pins (122, 124) of the pin assembly 120 disposed within the bores 115. In this regard, in some embodiments, the distal end of the top and bottom jaws (106, 108) may include a planar surface 117 at the tip rather than the jaws (106, 108) forming a point. As shown in FIG. 6, the planar surfaces 117 at the top and bottom jaws (106, 108), respectively, may not be coplanar with one another. In other words, the end of the top and bottom jaws (106, 108) may each be planar, but they may not both lie in the same plane as the other. Thus, when viewed from the side, such as in FIG. 6, the top and bottom jaws (106, 108) may appear to form a widened “V” shape at the distal end of the head section 102 with the hand tool in the closed state.

The pin assembly 120 depicted in FIG. 6 may include first and second pins (122, 124) that may be substantially cylindrical in shape. The substantially cylindrical pins (122, 124) may operably couple to the orifices of the circlip by being inserted into the orifices of the circlip. Thus, the pin assembly 120 may directly interact with the circlip via the curved surface of the substantially cylindrical pins (122, 124). However, in some embodiments, the pin assembly 120 may be shaped in a variety of ways in order to maximize the case and security of the operable coupling between the pin assembly 120 and the circlip. For example, the pins (122, 124) may be conical, frustoconical, or tapered. In this regard, the conical, frustoconical or tapered shaped may make it easier to insert the first and second pins (122, 124) into the orifices of the circlip. The farther that the pins (122, 124) are inserted into the circlip orifices, the more secure the operable coupling between the pin assembly 120 and the circlip may be, due to the angled shape of the pin assembly 120 and the increased friction force on the circlip as a result of the shape of the pin assembly 120.

In some cases, the pin assembly 120 may include a circlip holding rim 150 disposed at a distal end of the first and second pins (122, 124). The circlip holding rim 150 may increase the cross sectional area of the first and second pins (122, 124) so that the pin assembly 120 is more likely to remain operably coupled to the circlip when the hand tool 100 is in use. In this regard, as shown in FIG. 6, the circlip holding rim 150 may angularly extend from the distal end of the first and second pins (122, 124) such that the distal end of the first and second pins (122, 124) appears to have an inverted frustoconical shape that makes the first and second pins (122, 124) wider at the distal end thereof. Similarly, in other embodiments, the pin assembly 120 may include a circlip holding rim 150 that may be flared rather than angular. In this regard, the flared circlip holding rim 150 may add a radius of curvature to the angle formed between the length of the first and second pins (122, 124) and an end surface of the first and second pins (122, 124).

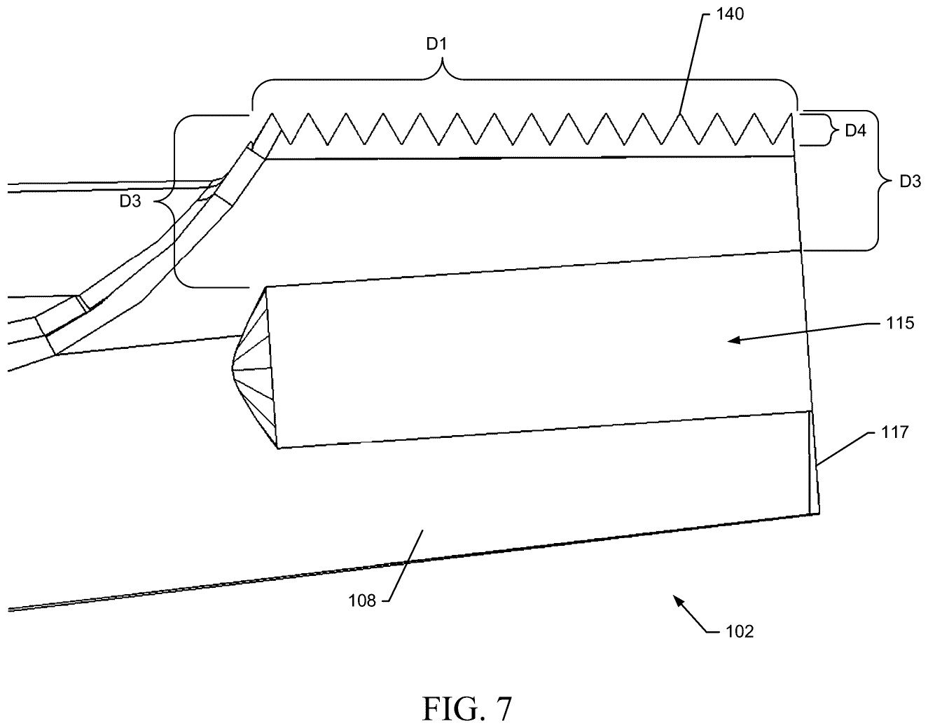

FIG. 7 depicts a close-up section view of the second gripping surface 134 and the bore 115 of the bottom jaw 108 according to an example embodiment. The gray shaded regions of FIG. 7 may be indicative of solid material of the bottom jaw 108 that has been sectioned through in order to visualize the bore 115 and the teeth 140. As shown in FIG. 7, the bore 115 may be formed within the top and bottom jaws (106, 108) and extend in a direction normal to the planar surface 117 at the tip of the respective jaws (106, 108) so that the first and second pins (122, 124) that may be disposed within the bores 115 may also extend normal to the planar surface 117 at the tip of the top and bottom jaws (106, 108). In this regard, a distance (D3) between the first and second gripping surfaces (132, 134) and the bores 115 for the first and second pins (122, 124), respectively, may be within a range of roughly 3 to 4 times a depth (D4) of the teeth 140 measured from the tip of the each tooth to a base point located between consecutive teeth 140. The range of values for (D3) may be a result of the bores 115 being nonparallel to the first and second gripping surfaces (132, 134). Accordingly, the distance between the bore 115 and the teeth 140 may be a minimum value at the planar surface 117 and a maximum value at the bottom of the bore 115. In some cases, the first and second gripping surfaces (132, 134) may have a length (D1) that is substantially equal to a depth of the bores 115. In some embodiments, the top jaw 106 may be a mirror image of the components of the bottom jaw 108 shown here in FIG. 7. In this regard, the longitudinal centerline 101 may be the line over which the bottom jaw is reflected to depict the top jaw 106.

Of note, the act of creating the bores 115 in the planar surfaces 117 of the top and bottom jaws (106, 108) may reduce the overall structural integrity of the head section 102 of the hand tool 100. Thus, to counteract this reduction and improve the structural integrity of the hand tool 100, and to maintain the grip strength of the top and bottom jaws (106, 108), the top and bottom jaws (106, 108) may include additional material supporting the first and second gripping surfaces (132, 134), respectively. The additional material may account for some of the distance between the teeth 140 and the bore 115 by supporting the first and second gripping surfaces (132, 134) at an angle to the bore 115. In this regard, the top and bottom jaws (106, 108) may be both widened and reinforced.

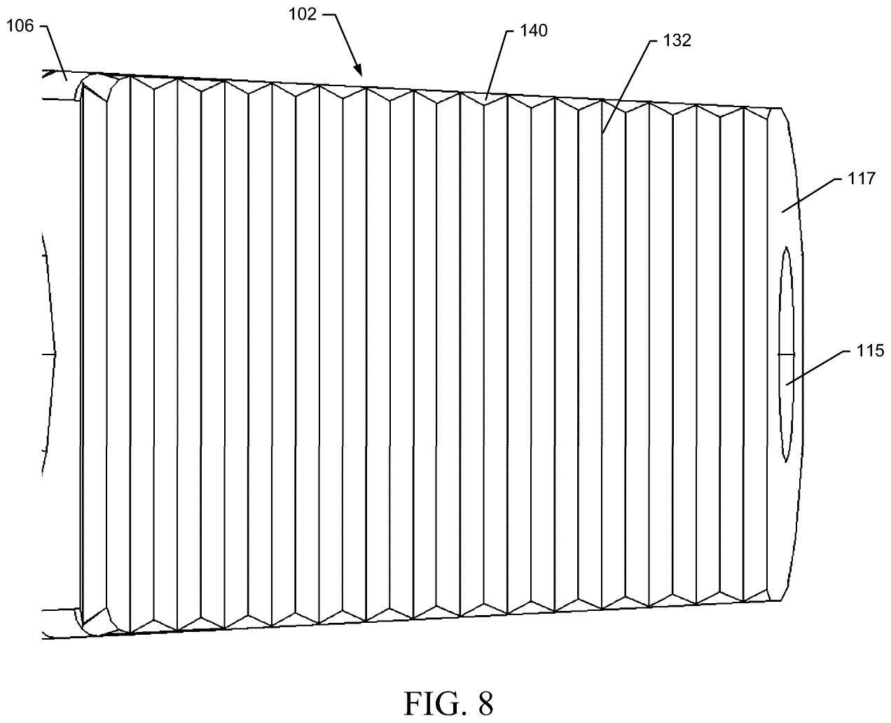

FIG. 8 depicts a close-up, top down view, of the first gripping surface 132 according to an example embodiment. In some cases, the second gripping surface 134 may be visually indiscernible from the first gripping surface 132, the main difference may be that the first gripping surface 132 may be disposed at the top jaw 106 while the second gripping surface 134 may be disposed at the bottom jaw 108. When viewed from above, as depicted in FIG. 8, the first gripping surface 132 may be substantially trapezoidal in shape. In other words, the first gripping surface 132 may include two edges that are parallel to one another, one of which may be longer than the other, and two other edges that are of equal lengths but converge towards one another. In this case, the edge of the first gripping surface 132 that may be disposed most towards the joint assembly 110 may be longer than the edge of the first gripping surface 132 that may be disposed at the distal end of the top jaw 106 proximate to the planar surface 117. The two converging edges may align with the edges of the top jaw 106 and may converge with the taper of the top jaw 106 towards the planar surface 117. In other words, the first and second gripping surfaces (132, 134) may have a smallest width proximate to the distal end of the head section 102. Said smallest width may be approximately equal to two times a diameter of the bore 115. The first and second gripping surfaces (132, 134) may thus also have a largest width at an opposite end of the gripping assembly 130 from the smallest width. Said largest width may be approximately equal to three times a diameter of the bore 115.

Additionally, as a result of the added material supporting the first and second gripping surfaces (132, 134) the first and second gripping surfaces (132, 134) may include a greater contact area at the distal end of each jaw (106, 108). In this regard, the top and bottom jaws (106, 108) may be rounded along a majority of the length of the jaw until the gripping assembly 130. The gripping assembly 130 utilizes the additional material to provide a level contact area for each of the first and second gripping surfaces (132, 134). In other words, without the addition of material to support the gripping assembly 130, the gripping assembly 130 may not be as effective.

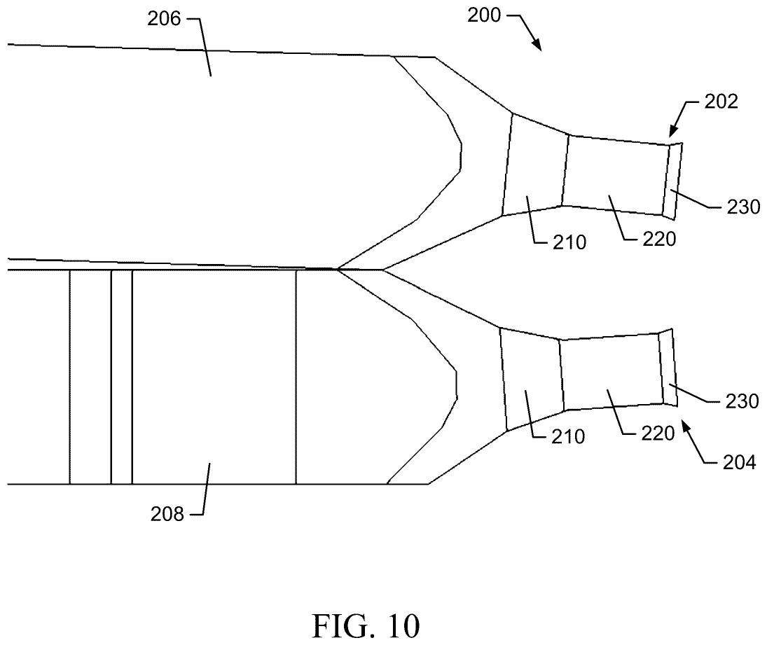

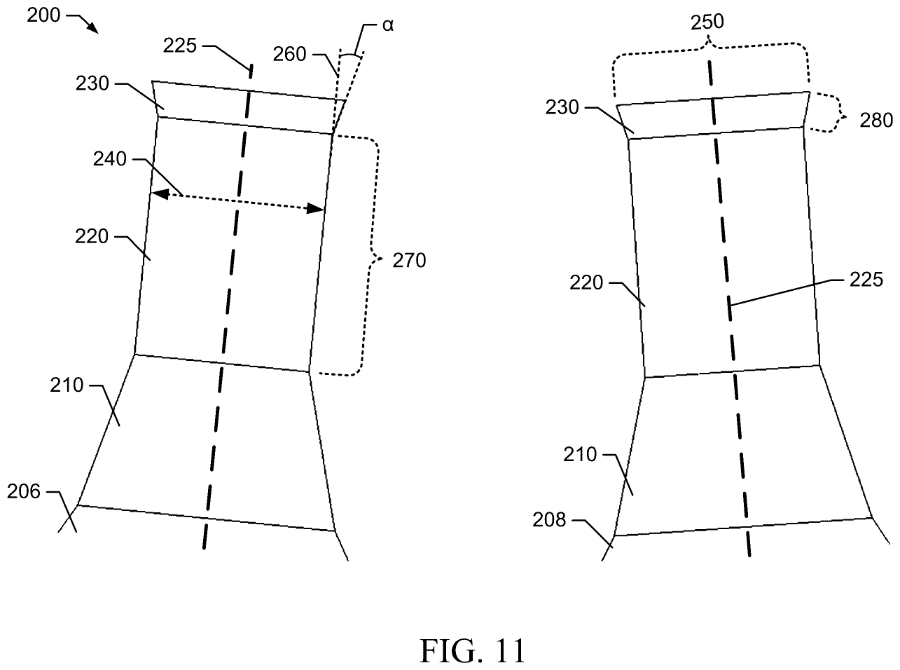

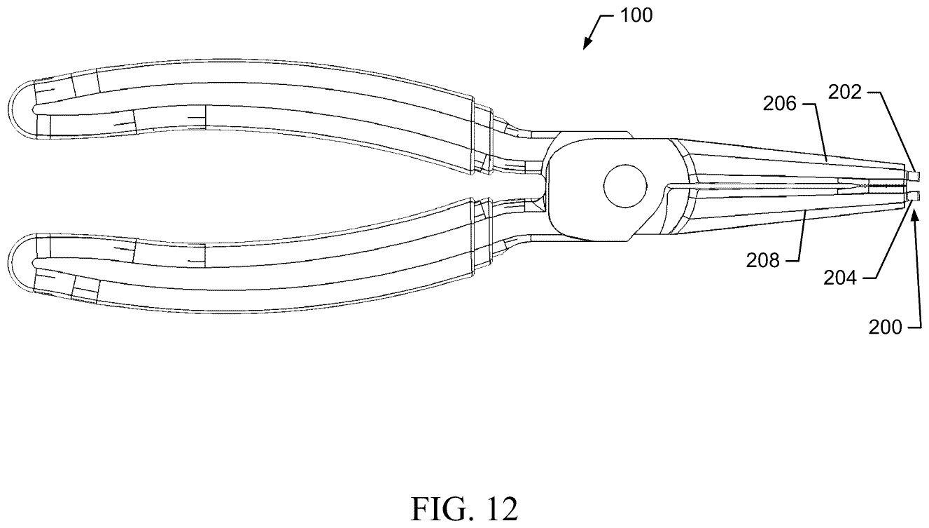

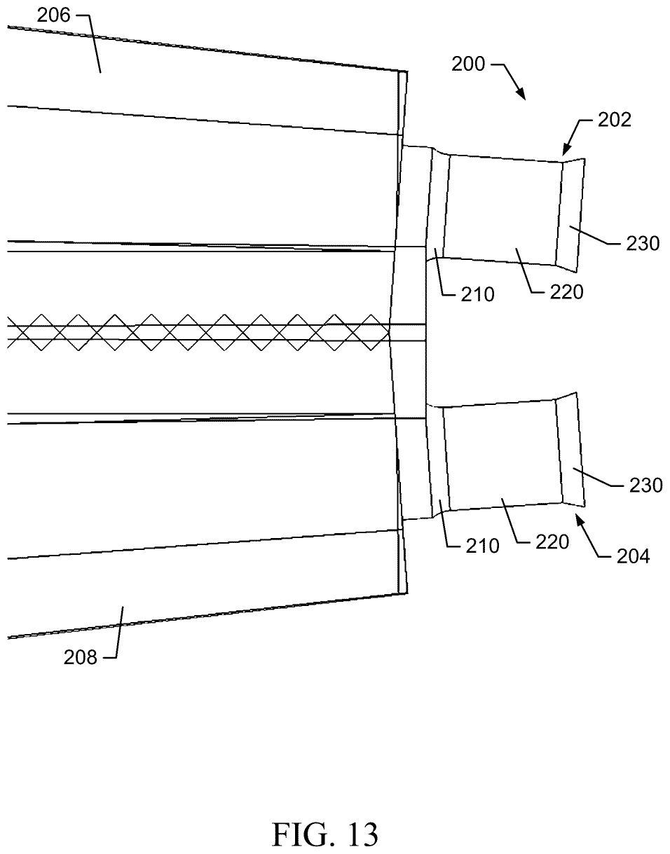

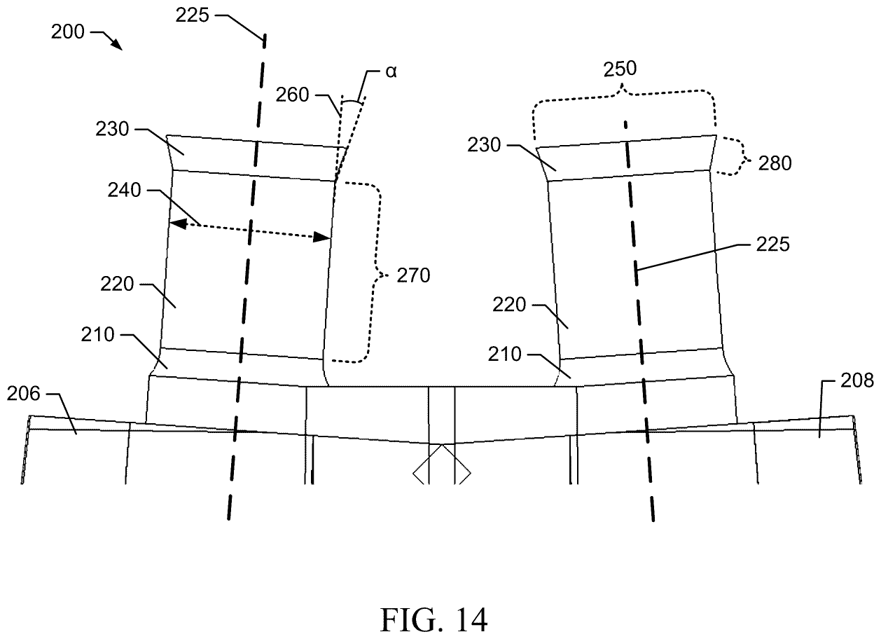

FIG. 9 illustrates the hand tool 100 according to a second example embodiment, and FIGS. 10 and 11 depict close up side views of the tip assembly 200 of the hand tool 100 in accordance with the second example embodiment. Similarly, FIG. 12 illustrates the hand tool 100 according to a third example embodiment, and FIGS. 13 and 14 depict close up side views of the tip assembly 200 of the hand tool 100 in accordance with the third example embodiment.

As described above in reference to the pin assembly 120 depicted in FIG. 6, the tip assembly 200 depicted in FIGS. 9-14 may include first and second tips (202, 204). The first and second tips (202, 204) may each include a base portion 210, a cylindrical body portion 220 and a retention lip 230. The base portion 210 may be disposed between the cylindrical body portion 220 and the respective one of the top jaw 206 and the bottom jaw 208 from which the respective one of the first tip 202 and the second tip 204 may extend. The retention lip 230 may be disposed at a distal end of the cylindrical body portion 220, on an opposite side of the cylindrical body portion 220 from the base portion 210. In some cases, the cylindrical body portion 220 may be substantially cylindrical in shape. The first and second tips (202, 204) may be integrally formed from the top and bottom jaws (206, 208), respectively, and disposed at the respective distal ends thereof. In an example embodiment, the first and second tips (202, 204) may operably couple to the orifices of the circlip by being inserted into the orifices of the circlip. Thus, the tip assembly 200 may directly interact with the circlip via the curved surface of the cylindrical body portion 220. However, in some embodiments, the tip assembly 200 may be shaped in a variety of ways in order to maximize the case and security of the operable coupling between the tip assembly 200 and the circlip.

In some cases, the retention lip 230 disposed at the distal end of the first and second tips (202, 204) may increase the cross sectional area of the first and second tips (202, 204) so that the tip assembly 200 may be more likely to remain operably coupled to the circlip when the hand tool 100 is in use. In this regard, as shown in FIGS. 9-14, the circlip retention lip 230 may extend angularly out from the distal end of the first and second tips (202, 204) such that the distal end of the first and second tips (202, 204) may be wider at the distal end thereof. In some cases, the retention lip 230 may have an inverted frustoconical shape. In this regard, the cylindrical body portion 220 may include a first diameter 240 and the retention lip 230 may include a second diameter 250. Due to the frustoconical shape of the retention lip 230, the second diameter 250 may be larger than the first diameter 240. In an example embodiment, the frustoconical shape of the retention lip 230 may be defined by the retention lip 230 extending away from the cylindrical body 220 and the first diameter 240 at an angle (α) of approximately 30° to the second diameter 250. In other words, the angle (α) may be measured between a generatrix line 260 that may extend up through the retention lip 230 and may be parallel to a longitudinal axis 225 of the cylindrical body portion 220 and may be disposed at an edge of the cylindrical body portion 220. The measurement of 30° may be critical to the operation of the tip assembly 200. In this regard, 30° may provide the best retention of the circlip on the tip assembly 200 to avoid unintentional removal of the circlip from the tip assembly 200. Additionally, 30° may also enable the tip assembly 200 to be intentionally removed from the circlip with relative ease when desired. As such, the angle (α) being approximately 30° may be critical to provide the best possible blend of case of operably coupling to the circlip, case of retaining the circlip on the tip assembly 200 and case of removing the circlip from the tip assembly 200 when desired. In some cases, the angle (α) may have a tolerance of +3°.

When operably coupling to a circlip, the first and second tips (202, 204) of the tip assembly 200 may be inserted into respective first and second orifices disposed at the circlip. In this regard, the first tip 202, including the retention lip 230 and some of the cylindrical body portion 220, may extend through the first orifice of the circlip, and the second tip 204, including the retention lip 230 and some of the cylindrical body portion 220, may extend through the second orifice of the circlip. The respective orifices of the circlip may therefore need to pass by the second diameter 250 of the retention lip 230 before they may settle somewhere along the first diameter 240 at the curved surface of the cylindrical body portion 220 when the hand tool 100 is in use. Accordingly, the first diameter 240 corresponding to the cylindrical body portion 220 and the second diameter 250 corresponding to the retention lip 230 may have a specific relationship to define their respective sizes that may enable the tip assembly 200 to effectively operably couple to, and open or close, the circlip.

Table 1 below shows a few non-limiting examples of the relationship between the first diameter 240 and the second diameter 250 for various standard circlip sizes. Additionally, the American Society of Mechanical Engineers (ASME) sets out recommended specifications for a diameter of the tips (202, 204) of the tip assembly 200. Table 1 below includes the ASME circlip (orifice) size in the first column on the far left side of Table 1, with each row representing a different size circlip orifice. The second column in from the left may then indicate what the ASME recommends to use as the diameter of the tips (202, 204) of the tip assembly 200 for that particular size circlip orifice. The remaining columns may include measurements of the first and second diameters (240, 250) for the respective size circlip orifice highlighted in each row. Sec Table 1 below.

TABLE 1
Comparison of first and second diameters (240, 250) to ASME recommended specifications

| ASME Circlip | ASME | First | Second | First | Second |
|---|---|---|---|---|---|
| Orifice Size | Recommended Tip | Diameter | Diameter | Diameter | Diameter |
| (inches) | Diameter (inches) | 240 (inches) | 250 (inches) | 240 (mm) | 250 (mm) |
| 0.041 (+0.010/−0.002) | 0.037 (+0.001/−0.002) | 0.036 (+0.002) | 0.040 (+0.000/−0.002) | 0.92 (+0.05) | 1.02 (+0.00/−0.05) |
| 0.052 (+0.010/−0.002) | 0.047 (+0.000/−0.008) | 0.044 (+0.002) | 0.049 (+0.000/−0.002) | 1.13 (+0.05) | 1.25 (+0.00/−0.05) |
| 0.078 (+0.015/−0.002) | 0.070 (+0.002/−0.005) | 0.066 (+0.002) | 0.074 (+0.000/−0.002) | 1.69 (+0.05) | 1.88 (+0.00/−0.05) |
| 0.093 (+0.015/−0.002) | 0.090 (+0.000/−0.008) | 0.081 (+0.002) | 0.090 (+0.000/−0.002) | 2.06 (+0.05) | 2.29 (+0.00/−0.05) |

As can be seen in Table 1 above, the first and second diameters (240, 250) may differ from both each other and from the ASME recommended tip diameter. In this regard, the first diameter 240 may be less than the ASME recommended tip diameter, while the second diameter 250 may be greater than (or in some cases, equal to) the ASME recommended tip diameter. Having the first diameter 240 be less than the ASME recommended tip diameter may enable the retention lip 230 and the second diameter 250 to be larger than the first diameter 240 to retain the circlip on the tip assembly 200. Additionally, the second diameter being greater than or equal to the ASME recommended tip diameter and simultaneously less than the ASME circlip orifice diameter may enable the tip assembly 200 to be small enough to fit into the circlip orifices, but large enough to retain the circlip on the tip assembly 200 via the retention lip 230.

The values presented in Table 1 above corresponding to the first and second diameters (240, 250) may be considered critical-to-quality (CTQ) for the hand tool 100. That is, the hand tool 100 may have been thoroughly tested to determine that the values presented above are critical to optimizing the success/efficiency of operating the hand tool 100. In other words, a tip assembly 200 having first and second tips (202, 204) that have the first and second diameter (240, 250) dimensions provided above may provide the best possible operation of the hand tool 100. In fact, not only are the dimensions presented in Table 1 of the first and second diameters (240, 250) critical, but they may be unexpected as well. For instance, making the second diameter 250 larger than the ASME recommended tip diameter and the first diameter 240 smaller than the ASME recommended tip diameter is a decision that may be unconventional and perhaps surprising. However, testing has shown that the combination of having the second diameter 250 larger than the ASME recommended tip diameter and the first diameter 240 smaller than the ASME recommended tip diameter may be critical to the improved operation of the hand tool 100.

As shown in Table 1 above, in some cases the first diameter 240 may be approximately 85% to 95% of the second diameter 250. More specifically, the first diameter 240 may be approximately 89% to 90% of the second diameter 250. In an example embodiment, the first diameter 240 may be approximately 85% to 95% of the ASME specification for tip diameter. More specifically, the first diameter 240 may be approximately 87.8% to 89.5% of the ASME specification for tip diameter. In some cases, the second diameter 250 may be approximately 100% to 125% of the ASME specification for tip diameter. More specifically, the second diameter 250 may be approximately 109.7% to 119.5% of the ASME specification for tip diameter. In an example embodiment, the ratio of the second diameter 250 to the first diameter 240 may be approximately 1.11:1. The relationships between the first diameter 240, the second diameter 250 and the ASME specification for tip diameter listed above may be considered critical to the success of the tip assembly 200. These ratios may provide the best possible blend of case of operably coupling to the circlip, case of retaining the circlip on the tip assembly 200, case of removing the circlip from the tip assembly 200 when desired, and withstanding shear forces applied from the circlip on the cylindrical body portion 220 when the hand tool 100 may be in use.

In some cases, the relative lengths of the retention lip 230 and the cylindrical body portion 220 may also be related to each other in critical ratios. In this regard, a first length 270 may be measured from an intersection of the base portion 210 and the cylindrical body portion 220 to an intersection of the cylindrical body portion 220 and the retention lip 230. A second length 280 may be measured from the intersection of the cylindrical body portion 220 and the retention lip 230 to the distal end of the first and second tips (202, 204). Thus, the first length 270 may correspond to the cylindrical body portion 220 and the second length 280 may correspond to the retention lip 230. In some cases, the second length 280 may be 10% to 25% of the first length 270. More specifically, the second length 280 may be 13% to 22% of the first length 270. This ratio of second length 280 to first length 270 may be critical to enabling the tip assembly 200 to be easily inserted into the circlip orifices while still maintaining sufficient retention of the circlip on the tip assembly 200 as well. Table 2 below provides some examples of the first and second lengths (270, 280) in accordance with various example embodiments.

TABLE 2
Comparison of first and second lengths
(270, 280) for each common circlip size

| | | First | Second |
|---|---|---|---|
| ASME Circlip | ASME | Length | Length |
| Orifice Size | Recommended Tip | 270 | 280 |
| (inches) | Diameter (inches) | (inches) | (inches) |
| 0.041 (+0.010/−0.002) | 0.037 (+0.001/−0.002) | 0.0549 | 0.0075 |
| 0.052 (+0.010/−0.002) | 0.047 (+0.000/−0.008) | 0.0605 | 0.0088 |
| 0.078 (+0.015/−0.002) | 0.070 (+0.002/−0.005) | 0.0831 | 0.0140 |
| 0.093 (+0.015/−0.002) | 0.090 (+0.000/−0.008) | 0.0801 | 0.0169 |

Some example embodiments may provide for circlip pliers. The circlip pliers may include a head section which may include a top jaw and a bottom jaw, a handle section which may include a top handle and a bottom handle, a joint assembly which may operably couple the head section to the handle section, and a tip assembly which may include a first tip which may be disposed at a distal end of the top jaw and a second tip which may be disposed at a distal end of the bottom jaw. The first and second tips may each include a base portion, a cylindrical body portion and a retention lip which may be disposed at a distal end of the cylindrical body portion. The circlip pliers of some embodiments may include additional, optional features,

and/or the features described above may be modified or augmented. Some examples of modifications, optional features and augmentations are described below. It should be appreciated that the modifications, optional features and augmentations listed below may each be added alone, or they may be added cumulatively in any desirable combination. For example, in some embodiments, the cylindrical body portion may include a first diameter and the retention lip may include a second diameter. In some cases, the second diameter may be larger than the first diameter. In an example embodiment, the retention lip may be frustoconical in shape. In some cases, the retention lip may extend from the first diameter to the second diameter at an angle of approximately 30 degrees from the cylindrical body portion. In an example embodiment, the first diameter may be 85% to 95% of the second diameter. In some cases, the first diameter may be 89% to 90% of the second diameter. In an example embodiment, the first diameter may be 85% to 95% of an American Society of Mechanical Engineers (ASME) specification for tip diameter. In some cases, the first diameter may be 87.8% to 89.5% of the ASME specification for tip diameter. In an example embodiment, the second diameter may be 100% to 125% of an American Society of Mechanical Engineers (ASME) specification for tip diameter. In some cases, the second diameter may be 109.7% to 119.5% of the ASME specification for tip diameter. In an example embodiment, the cylindrical body portion may include a first length and the retention lip may include a second length. In some cases, the second length may be 10% to 25% of the first length.

Some example embodiments may provide for a tip assembly for circlip pliers which may include a head section which may include a top jaw and a bottom jaw, a handle section which may include a top handle and a bottom handle, and a joint assembly which may operably couple the head section to the handle section. The tip assembly may include a first tip which may be disposed at a distal end of the top jaw, and a second tip which may be disposed at a distal end of the bottom jaw. The first and second tips may each include a base portion, a cylindrical body portion and a retention lip which may be disposed at a distal end of the cylindrical body portion.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed:

1. A circlip pliers comprising:
a head section comprising a top jaw and a bottom jaw;
a handle section comprising a top handle and a bottom handle;
a joint assembly operably coupling the head section to the handle section; and
a tip assembly having a first tip disposed at a distal end of the top jaw and a second tip disposed at a distal end of the bottom jaw; and
wherein the first and second tips each comprise a base portion, a cylindrical body portion and a retention lip disposed at a distal end of the cylindrical body portion.

2. The circlip pliers of claim 1, wherein the cylindrical body portion comprises a first diameter and the retention lip comprises a second diameter, and
wherein the second diameter is larger than the first diameter.

3. The circlip pliers of claim 2, wherein the retention lip is frustoconical in shape.

4. The circlip pliers of claim 3, wherein the retention lip extends from the first diameter to the second diameter at an angle of approximately 30 degrees from the cylindrical body portion.

5. The circlip pliers of claim 2, wherein the first diameter is 85% to 95% of the second diameter.

6. The circlip pliers of claim 5, wherein the first diameter is 89% to 90% of the second diameter.

7. The circlip pliers of claim 2, wherein the first diameter is 85% to 95% of an American Society of Mechanical Engineers (ASME) specification for tip diameter.

8. The circlip pliers of claim 7, wherein the first diameter is 87.8% to 89.5% of the ASME specification for tip diameter.

9. The circlip pliers of claim 2, wherein the second diameter is 100% to 125% of an American Society of Mechanical Engineers (ASME) specification for tip diameter.

10. The circlip pliers of claim 9, wherein the second diameter is 109.7% to 119.5% of the ASME specification for tip diameter.

11. The circlip pliers of claim 1, wherein the cylindrical body portion comprises a first length and the retention lip comprises a second length, and wherein the second length is 10% to 25% of the first length.

12. A tip assembly for circlip pliers having a head section comprising a top jaw and a bottom jaw, a handle section comprising a top handle and a bottom handle, and a joint assembly operably coupling the head section to the handle section, the tip assembly comprising:
a first tip disposed at a distal end of the top jaw; and
a second tip disposed at a distal end of the bottom jaw,
wherein the first and second tips each comprise a base portion, a cylindrical body portion and a retention lip disposed at a distal end of the cylindrical body portion.

13. The tip assembly of claim 12, wherein the cylindrical body portion comprises a first diameter and the retention lip comprises a second diameter, and
wherein the second diameter is larger than the first diameter.

14. The tip assembly of claim 13, wherein the retention lip is frustoconical in shape, and
wherein the retention lip extends from the first diameter to the second diameter at an angle of approximately 30 degrees from the cylindrical body portion.

15. The tip assembly of claim 13, wherein the first diameter is 89% to 90% of the second diameter.

16. The tip assembly of claim 13, wherein the first diameter is 85% to 95% of an American Society of Mechanical Engineers (ASME) specification for tip diameter.

17. The tip assembly of claim 16, wherein the first diameter is 87.8% to 89.5% of the ASME specification for tip diameter.

18. The tip assembly of claim 13, wherein the second diameter is 100% to 125% of an American Society of Mechanical Engineers (ASME) specification for tip diameter.

19. The tip assembly of claim 18, wherein the second diameter is 109.7% to 119.5% of the ASME specification for tip diameter.

20. The tip assembly of claim 12, wherein the cylindrical body portion comprises a first length and the retention lip comprises a second length, and
wherein the second length is 10% to 25% of the first length.
